(19) United States
(12) Patent Application Publication
(10) Pub. No.: US 2016/0028103 A1
(43) Pub. Date: Jan. 28, 2016

(54) ELECTRODE ASSEMBLY, LITHIUM BATTERY, AND METHOD FOR PRODUCING ELECTRODE ASSEMBLY

(71) Applicant: SEIKO EPSON CORPORATION, Tokyo (JP)

(72) Inventors: Tomofumi YOKOYAMA, Matsumoto-shi (JP); Sukenori ICHIKAWA, Suwa-shi (JP); Yasushi YAMAZAKI, Azumino-shi (JP); Masahiro FURUSAWA, Chino-shi (JP)

(21) Appl. No.: 14/801,400

(22) Filed: Jul. 16, 2015

(30) Foreign Application Priority Data
Jul. 23, 2014 (JP) 2014-149511

(51) Int. Cl. H01M 10/056; H01M 10/0525

(52) U.S. Cl. CPC H01M 10/056; H01M 10/0525; H01M 2300/0065

(57) ABSTRACT

A precursor of a solid electrolyte is melted at a temperature lower than the melting point of an active material, a liquid electrolyte material is placed on a surface of an active material molded body having voids among multiple active material particles of the active material, and the liquid electrolyte material is solidified, whereby a solid electrolyte layer is formed.

### BACKGROUND

1. Technical Field

This application claims a priority to Japanese Patent Application No. 2014-149511 filed on Jul. 23, 2014 which is hereby expressly incorporated by reference in its entirety.

Several aspects of the present invention relates to an electrode assembly, a lithium battery, and a method for producing an electrode assembly.

2. Related Art

As a power source for many electronic devices such as portable information devices, a lithium battery (including a primary battery and a secondary battery) has been used. The lithium battery includes a positive electrode, a negative electrode, and an electrolyte layer which is placed between the layers of these electrodes and mediates conduction of lithium ions.

Recently, as a lithium battery having a high energy density and safety, an all-solid-state lithium battery has been developed. All-solid-state lithium batteries using a solid electrolyte as a constituent material of an electrolyte layer have been disclosed in JP-A-2009-215130, JP-A-2001-68149, JP-A-2000-311710, JP-A-2008-226666, JP-A-2006-260887, and JP-A-2011-204511.

As the lithium battery, a high-power lithium battery has been demanded, however, an all-solid-state lithium battery in the related art does not have sufficient performance. Accordingly, a method for producing an electrode assembly capable of producing a higher-power electrode assembly and a higher-power lithium battery has been demanded.

### SUMMARY

An advantage of some aspects of the invention is to solve the problem described above, and the invention can be implemented as the following embodiments or application examples.

### Application Example 1

This application example is directed to a method for producing an electrode assembly including: melting a precursor of a solid electrolyte at a temperature lower than the melting point of an active material; placing the precursor on a surface of an active material molded body having voids among multiple particles of the active material; and solidifying the precursor, whereby the solid electrolyte is formed.

According to this application example, the active material molded body has voids among multiple particles of the active material. Then, the melted precursor of the solid electrolyte is placed on the surface of the active material molded body. Since the precursor spreads on the surface of the active material molded body through the voids, the surface of the active material molded body can be reliably covered with the precursor.

The precursor of the solid electrolyte is melted at a temperature lower than the melting point of the active material. According to this, it is possible to suppress the voids among the particles from being narrowed by the precursor. Accordingly, a contact area between the active material molded body and the solid electrolyte is increased, and thus an interface impedance between the active material molded body and a solid electrolyte layer can be decreased. Due to this, favorable charge transfer at an interface between the active material molded body and the solid electrolyte layer can be achieved. As a result, an electrode assembly which facilitates charge transfer and has a high output power can be produced.

### Application Example 2

This application example is directed to the method for producing an electrode assembly according to the application example described above, wherein the precursor contains a solvent which lowers the melting point of the precursor.

According to this application example, the precursor contains a solvent which lowers the melting point of the precursor. Therefore, the precursor of the solid electrolyte can be melted at a temperature lower than the melting point of the active material.

### Application Example 3

This application example is directed to the method for producing an electrode assembly according to the application example described above, wherein the solvent is a salt.

According to this application example, the precursor contains a salt which lowers the melting point of the precursor. Therefore, the precursor can be melted at a temperature lower than the melting point of the active material by lowering the melting point of the precursor.

### Application Example 4

This application example is directed to an electrode assembly including: an active material molded body having voids among multiple particles of an active material; and a solid electrolyte covering a surface of the active material molded body, wherein the solid electrolyte contains a crystalline electrolyte and an amorphous electrolyte.

According to this application example, the electrode assembly includes an active material molded body and a solid electrolyte. The surface of the active material molded body is covered with the solid electrolyte. The active material molded body has voids among multiple particles of the active material. By melting the precursor of the solid electrolyte, the precursor of the solid electrolyte can be placed on the surface of the active material molded body. At this time, the precursor spreads on the surface of the active material molded body through the voids, and therefore, the surface of the active material molded body can be reliably covered with the precursor.

The solid electrolyte contains a crystalline electrolyte and an amorphous electrolyte. Therefore, a particle interface resistance of the crystalline solid electrolyte can be decreased by forming a composite material with the amorphous electrolyte. According to this, the solid electrolyte layer can achieve favorable charge transfer at an interface. As a result, the electrode assembly facilitates charge transfer, and therefore, a high-power electrode assembly can be formed.

### Application Example 5

This application example is directed to a lithium battery including: an active material molded body having voids among multiple particles of an active material; and a solid electrolyte covering a surface of the active material molded body, wherein the solid electrolyte contains a crystalline electrolyte and an amorphous electrolyte.

According to this application example, the lithium battery includes an active material molded body and a solid electrolyte. The surface of the active material molded body is covered with the solid electrolyte. The active material molded body has voids among multiple particles of the active material. By melting the precursor of the solid electrolyte, the precursor of the solid electrolyte can be placed on the surface of the active material molded body. At this time, the precursor spreads on the surface of the active material molded body through the voids, and therefore, the surface of the active material molded body can be reliably covered with the precursor.

The solid electrolyte contains a crystalline electrolyte and an amorphous electrolyte. Therefore, a particle interface resistance of the crystalline solid electrolyte can be decreased by forming a composite material with the amorphous electrolyte. According to this, the solid electrolyte layer can achieve favorable charge transfer at an interface. As a result, the lithium battery facilitates charge transfer, and therefore, a high-power lithium battery can be formed.

### BRIEF DESCRIPTION OF THE DRAWINGS

The invention will be described with reference to the accompanying drawings, wherein like numbers reference like elements.

FIG. 1 is a schematic cross-sectional side view of a main part showing a structure of an electrode assembly according to a first embodiment.

FIG. 2 is a flow chart of a method for producing an electrode assembly.

FIGS. 3A to 3C are schematic views for illustrating the method for producing an electrode assembly.

FIGS. 4A and 4B are schematic views for illustrating the method for producing an electrode assembly.

FIGS. 5A and 5B are schematic views for illustrating the method for producing an electrode assembly.

FIG. 6A is a schematic cross-sectional side view showing a structure of an electrode assembly according to a second embodiment, and FIGS. 6B and 6C are schematic views for illustrating a method for producing an electrode assembly according to the second embodiment.

FIG. 7 is a schematic cross-sectional side view showing a structure of an electrode assembly according to a third embodiment.

FIGS. 8A and 8B are schematic views for illustrating a method for producing an electrode assembly according to a fourth embodiment.

FIG. 9 is a schematic cross-sectional side view of a main part showing a structure of a lithium battery according to a fifth embodiment.

FIG. 10 is a schematic cross-sectional side view of a main part showing a structure of a lithium battery according to a sixth embodiment.

### DESCRIPTION OF EXEMPLARY EMBODIMENTS

Hereinafter, embodiments will be described with reference to the drawings. Incidentally, the scales of the respective members in the respective drawings will be appropriately changed so that the respective members have a recognizable size in the respective drawings.

### First Embodiment

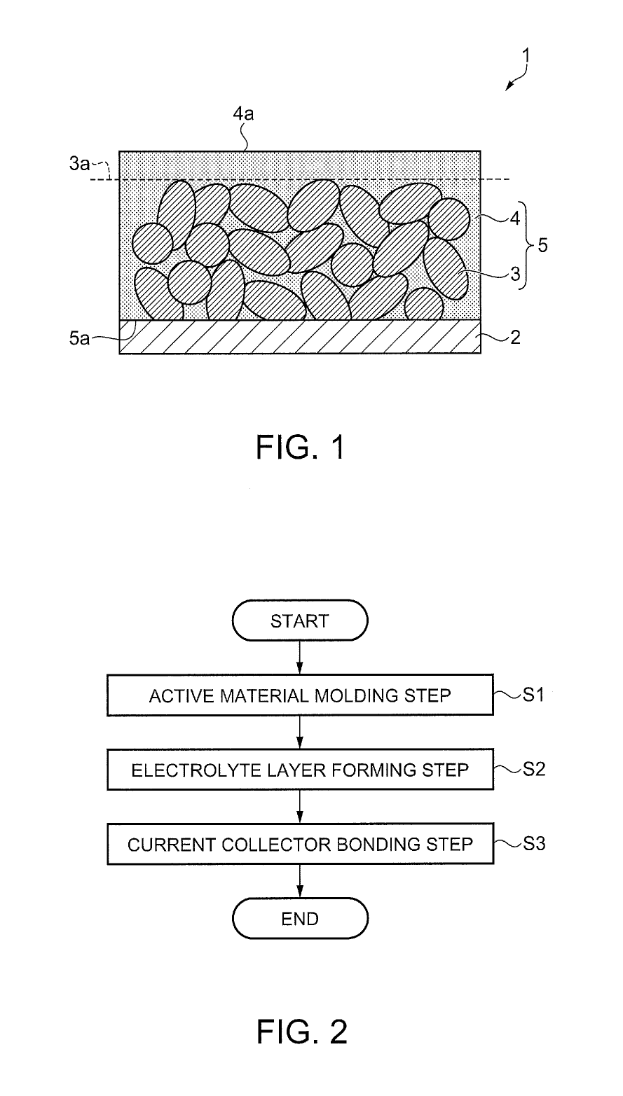

In this embodiment, characteristic examples of an electrode assembly and a method for producing an electrode assembly will be described with reference to FIGS. 1 to 5B.

FIG. 1 is a schematic cross-sectional side view of a main part showing a structure of an electrode assembly. As shown in FIG. 1, an electrode assembly 1 includes a current collector 2, an active material molded body 3, and a solid electrolyte layer 4 as a solid electrolyte. A structure in which the active material molded body 3 and the solid electrolyte layer 4 are combined is referred to as “composite body 5”. The electrode assembly 1 is used in a lithium battery.

The current collector 2 is provided in contact with the active material molded body 3 exposed from the solid electrolyte layer 4 on a surface 5a of the composite body 5. As a constituent material of the current collector 2, one type of metal (a metal simple substance) selected from the group consisting of copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and palladium (Pd), or an alloy containing two or more types of metal elements selected from this group can be used.

As the shape of the current collector 2, a plate, a foil, a mesh, or the like can be adopted. The surface of the current collector 2 may be smooth, or may have irregularities formed thereon.

The active material molded body 3 is a molded body composed of particles of an inorganic electrode active material (active material). The active material molded body 3 has voids among the multiple particles, and the respective voids communicate with one another in a mesh form.

### Structure of Electrode Assembly

The constituent material of the active material molded body 3 is different between the case where the current collector 2 is used on the positive electrode side and the case where it is used on the negative electrode side in a lithium battery. In the case where the current collector 2 is used on the positive electrode side, a material generally known as a positive electrode active material can be used as the constituent material of the active material molded body 3. Examples of such a material include lithium multiple oxides. The term “lithium multiple oxide” as used herein refers to an oxide inevitably containing lithium, and also containing two or more types of metal ions as a whole, but free of oxoacid ions.

Examples of such a lithium multiple oxide include LiCoO₂, LiNiO₂, LiMn₂O₄, Li₂Mn₂O₃, LiFePO₄, Li₂FeP₂O₇, LiMnPO₄, LiFeBO₃, Li₃V₂(PO₄)₃, Li₂CuO₂, LiFeF₃, Li₂FeSiO₄, and Li₂MnSiO₄. Further, solid solutions obtained by substituting some atoms in a crystal of any of these lithium multiple oxides with a transition metal, a typical metal, an alkali metal, an alkaline rare earth element, a lanthanoid, a chalcogenide, a halogen, or the like are also included in the lithium multiple oxide, and any of these solid solutions can also be used as the positive electrode active material.

In the case where the current collector 2 is used on the negative electrode side, a material generally known as a negative electrode active material can be used as the constituent material of the active material molded body 3. Examples of the negative electrode active material include silicon-manganese alloy (Si—Mn), silicon-cobalt alloy (Si—Co), silicon-nickel alloy (Si—Ni), niobium pentoxide (Nb₂O₅), vanadium pentoxide (V₂O₅), titanium oxide (TiO₂), indium oxide (In₂O₃), zinc oxide (ZnO), tin oxide (SnO₂), nickel oxide (NiO) tin (Sn)-added indium oxide (ITO), aluminum (Al)-added zinc oxide (AZO), gallium (Ga)-added zinc oxide (GZO), antimony (Sb)-added tin oxide (ATO), fluorine (F)-added tin oxide (FTO), a carbon material, a material obtained by intercalating lithium ions into layers of a carbon material, anatase-type titanium dioxide (TiO₂), lithium multiple oxides such as Li₄Ti₅O₁₂ and Li₂Ti₃O₇, and lithium (Li) metal. In this embodiment, for example, the current collector 2 is used as a positive electrode, and LiCoO₂ is used as the active material molded body 3.

The active material molded body 3 preferably has a void ratio of 10% or more and 50% or less. When the active material molded body 3 has such a void ratio, a surface area of the inside of the active material molded body 3 is increased, and also a contact area between the active material molded body 3 and the solid electrolyte layer 4 is easily increased. Accordingly, the capacity of a lithium battery using the electrode assembly 1 is easily increased.

The void ratio can be determined according to the following formula (I) from (1) the volume (apparent volume) of the active material molded body 3 including the voids obtained from the external dimension of the active material molded body 3, (2) the mass of the active material molded body 3, and (3) the density of the active material constituting the active material molded body 3.

$$Void ratio ( \% ) = ( 1 - \frac{mass of active material molded body}{( apparent volume ) \times ( density of active material )} ) \times 100 \qquad ( I )$$

The resistivity of the active material molded body 3 is preferably 700 Ω/cm or less. When the active material molded body 3 has such a resistivity, in the case of forming a lithium battery using the electrode assembly 1, a sufficient output power can be obtained. The resistivity can be determined by adhering a copper foil to be used as the electrode to the surface of the active material molded body, and then, performing DC polarization measurement.

The solid electrolyte layer 4 is composed of a solid electrolyte, and is provided in contact with the surface of the active material molded body 3 including the inside of the voids of the active material molded body 3.

Examples of the solid electrolyte include oxides, sulfides, halides, and nitrides such as SiO₂—P₂O₅—Li₂O, SiO₂—P₂O₅—LiCl, Li₂O—LiCl—B₂O₃, Li_{3.4}V_{0.6}Si_{0.4}O₄, Li₁₄ZnGe₄O₁₆, Li_{3.6}V_{0.4}Ge_{0.6}O₄, PO₄)₃, Li_{2.88}PO_{3.73}N_{0.14}, LiNbO₃, Li₂S—SiS₂—P₂S₅, LiPON, Li₃N, LiI, LiI—CaI₂, LiI—CaO, LiAlCl₄, LiAlF₄, LiI—Al₂O₃, LiF—Al₂O₃, LiBr—Al₂O₃, Li₂O—TiO₂, La₂O₃—Li₂O—TiO₂, Li₃N, Li₃NI₂, Li₃N—LiI—LiOH, Li₃N—LiCl, Li₆NBr₃, LiSO₄, Li₄SiO₄, Li₃PO₄—Li₄SiO₄, Li₄GeO₄—Li₃VO₄, Li₄SiO₄—Li₃VO₄, Li₄GeO₄— Zn₂GeO₂, Li₄SiO₄—LiMoO₄, Li₃PO₄—Li₄SiO₄, and LiSiO₄—Li₄ZrO₄. These solid electrolytes may be crystalline or amorphous. Further, in this specification, a solid solution obtained by substituting some atoms of any of these compositions with a transition metal, a typical metal, an alkali metal, an alkaline rare earth element, a lanthanoid, a chalcogenide, a halogen, or the like can also be used as the solid electrolyte.

The ionic conductivity of the solid electrolyte layer 4 is preferably 1×10⁻⁵ S/cm or more. When the solid electrolyte layer 4 has such an ionic conductivity, ions contained in the solid electrolyte layer 4 at a position away from the surface of the active material molded body 3 reach the surface of the active material molded body 3 and can also contribute to a battery reaction in the active material molded body 3. Accordingly, the utilization of the active material in the active material molded body 3 is improved, and thus the capacity can be increased. At this time, if the ionic conductivity is less than 1×10⁻⁵ S/cm, when the electrode assembly is used in a lithium battery, only the active material in the vicinity of the surface layer of the surface facing a counter electrode contributes to the battery reaction in the active material molded body 3, and therefore, the capacity may be decreased.

The term “ionic conductivity of the solid electrolyte layer 4” as used herein refers to the “total ionic conductivity”, which is the sum of the “bulk conductivity”, which is the conductivity of the above-mentioned inorganic electrolyte itself constituting the solid electrolyte layer 4, and the “grain boundary ionic conductivity”, which is the conductivity between crystal grains when the inorganic electrolyte is crystalline. The ionic conductivity of the solid electrolyte layer 4 can be determined as follows. A tablet-shaped body obtained by press-molding a solid electrolyte powder at 624 MPa is sintered at 700° C. in an air atmosphere for 8 hours, a platinum electrode having a diameter of 0.5 cm and a thickness of 100 nm is formed on both surfaces of the press-molded body by sputtering, and then, performing an AC impedance method. As the measurement device, an impedance analyzer (model SI1260, manufactured by Solartron Co., Ltd.) is used.

In the electrode assembly 1, the direction, which is away from the surface of the current collector 2 in the normal direction, and in which the composite body 5 is placed on the current collector 2, is defined as the upper direction. The upper side in the drawing is the upper direction. At this time, the surface 4a on the upper side of the solid electrolyte layer 4 is located in the upper direction than the upper edge position 3a of the active material molded body 3. That is, the solid electrolyte layer 4 is formed in the upper direction than the upper edge position 3a of the active material molded body 3. According to this configuration, when producing a lithium battery having the electrode assembly 1 by providing an electrode on the surface 4a, the electrode provided on the surface 4a and the current collector 2 are not electrically connected to each other through the active material molded body 3. Therefore, a short circuit between the electrode and the current collector 2 can be prevented.

The electrode assembly 1 of this embodiment is formed such that when molding the active material molded body 3, an organic material such as a binder for binding the active materials to each other or a conductive additive for securing the electrical conductivity of the active material molded body 3 is not contained, and is composed of almost only an inorganic material. Specifically, in the electrode assembly 1 of this embodiment, a mass loss percentage when the composite body 5 (the active material molded body 3 and the solid electrolyte layer 4) is heated to 400° C. for 30 minutes is 5% by mass or less. The mass loss percentage is preferably 3% by mass or less, more preferably 1% by mass or less, and particularly preferably, the mass loss is not observed or is within the limits of error. That is, the mass loss percentage when the composite body 5 is heated to 400° C. for 30 minutes is preferably 0% by mass.

Since the composite body 5 shows a mass loss percentage as described above, in the composite body 5, a material which is evaporated under predetermined heating conditions such as a solvent or adsorbed water, or an organic material which is vaporized by burning or oxidation under predetermined heating conditions is contained in an amount of only 5% by mass or less with respect to the total mass of the structure. The mass loss percentage of the composite body 5 can be determined as follows. By using a thermogravimetric/differential thermal analyzer (TG-DTA), the composite body 5 is heated under predetermined heating conditions, and the mass of the composite body 5 after heating under the predetermined heating conditions is measured, and the mass loss percentage is calculated from the ratio between the mass before heating and the mass after heating.

In the solid electrolyte layer 4, a salt is contained as a solvent. The type of the salt may be any as long as it has a function to lower the melting point of the precursor of the solid electrolyte layer 4, and is not particularly limited, however, NaCl, LiCl, or the like can be used.

The active material molded body 3 has voids among multiple particles of the active material, and the voids communicate with one another in a mesh form inside the active material molded body 3. Also, the solid portion of the active material molded body 3 forms a mesh structure. For example, LiCoO₂ which is a positive electrode active material is known to have anisotropic electron conductivity in crystals. In the case where LiCoO₂ has a structure such that voids are provided extending in a specific direction, electron conduction may possibly hardly take place therein depending on the direction in which electron conductivity is exhibited in crystals. However, if the voids communicate with one another in a mesh form as in the case of the active material molded body 3 and the solid portion of the active material molded body 3 has a mesh structure, an electrochemically smooth continuous surface can be formed regardless of the anisotropic electron conductivity or ionic conductivity in crystals. Accordingly, favorable electron conduction can be secured regardless of the type of active material to be used.

Further, since the composite body 5 has a configuration as described above, the addition amount of a binder or a conductive additive contained in the composite body 5 is reduced, and thus, as compared with the case where a binder or a conductive additive is used, the capacity density per unit volume of the electrode assembly 1 is improved.

Further, the solid electrolyte layer 4 is in contact also with the surfaces of the particles facing the voids among the particles of the active material molded body 3. In other words, the surface of the active material molded body 3 is covered with the solid electrolyte layer 4. Therefore, as compared with the case where the active material molded body 3 does not have voids communicating with one another or the case where the solid electrolyte layer 4 is not formed in the voids, a contact area between the active material molded body 3 and the solid electrolyte layer 4 is increased, and thus, an interface impedance can be decreased. Accordingly, favorable charge transfer at an interface between the active material molded body 3 and the solid electrolyte layer 4 can be achieved.

Further, the current collector 2 is in contact with the active material molded body 3 exposed on the surface 5a of the composite body 5. On the other hand, the solid electrolyte layer 4 penetrates into the voids in the active material molded body 3. In the electrode assembly 1 having such a configuration, a contact area between the active material molded body 3 and the solid electrolyte layer 4 is larger than a contact area between the current collector 2 and the active material molded body 3. The contact area between the current collector 2 and the active material molded body 3 is defined as “first contact area”, and the contact area between the active material molded body 3 and the solid electrolyte layer 4 is defined as “second contact area”. An electrical resistance per unit area of a surface in contact with the active material molded body 3 of the current collector 2 is low, and an electrical resistance per unit area of a surface in contact with the solid electrolyte layer 4 of the active material molded body 3 is high. At this time, the second contact area is larger than the first contact area, and therefore, an electrical charge transfers to the current collector 2 from the solid electrolyte layer 4 through the active material molded body 3. As a result, favorable charge transfer can be achieved in the electrode assembly 1 as a whole.

Accordingly, the electrode assembly 1 of this embodiment can improve the capacity of a lithium battery using the electrode assembly 1, and also the output power can be increased.

### Method for Producing Electrode Assembly

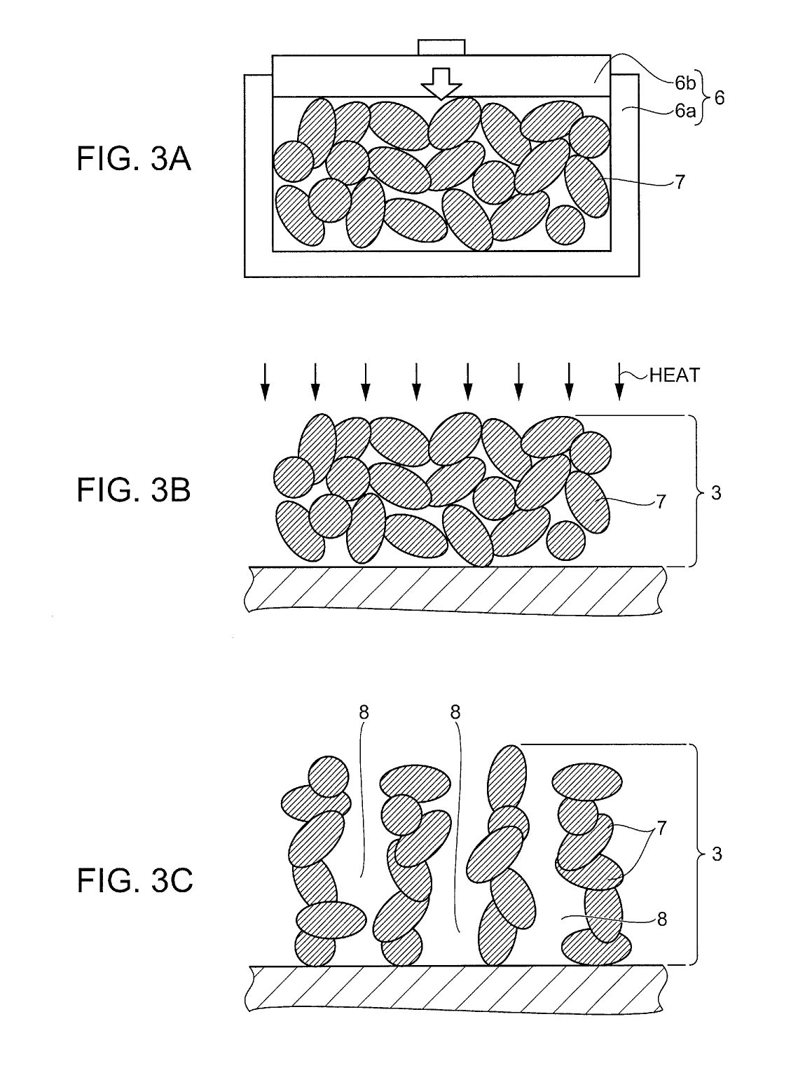

Next, a method for producing the electrode assembly 1 will be described. FIG. 2 is a flow chart of a method for producing an electrode assembly, and FIGS. 3A to 5B are schematic views for illustrating the method for producing an electrode assembly. In the flow chart shown in FIG. 2, Step S1 corresponds to an active material molding step, and is a step of molding a powder as a material of an active material molded body 3, followed by firing. Subsequently, the step proceeds to Step S2. Step S2 corresponds to an electrolyte layer forming step. This step is a step of placing a solid electrolyte layer 4 on the active material molded body 3, thereby forming a composite body 5. Subsequently, the step proceeds to Step S3. Step S3 corresponds to a current collector bonding step. This step is a step of bonding the composite body 5 and a current collector 2 to each other. According to the above steps, the electrode assembly 1 is completed.

Next, with reference to FIGS. 3A to 5B, the production method will be described in detail according to the steps shown in FIG. 2. FIGS. 3A to 3C are views corresponding to the active material molding step of Step S1. As shown in FIG. 3A, in Step S1, a molding die 6 is prepared. The molding die 6 is composed of a first cavity 6a and a second cavity 6b or the like. In the first cavity 6a, active material particles 7 are put. The active material particle 7 is an active material in the form of a particle. The active material particles 7 are compression-molded using the first cavity 6a and the second cavity 6b.

Subsequently, as shown in FIG. 3B, by performing a heat treatment of the molded active material particles 7, an active material molded body 3 is obtained. By performing the heat treatment, grain boundary growth in the active material particles 7 and sintering between the active material particles 7 are allowed to proceed. Due to this, the retention of the shape of the obtained active material molded body 3 is facilitated, and thus, the addition amount of a binder in the active material molded body 3 can be decreased. Further, a bond is formed between the active material particles 7 by sintering, and therefore, the addition amount of a conductive additive can also be decreased.

FIG. 3C is a schematic cross-sectional view of a main part of the active material molded body 3. As shown in FIG. 3C, the active material particles 7 of the active material molded body 3 are arranged sparsely. According to this, the active material molded body 3 has a structure having voids 8 among the active material particles 7. The active material molded body 3 is configured such that the active material particles 7 are connected to one another in a mesh form, and the voids 8 are surrounded by the active material particles 7. Then, the adjacent voids 8 communicate with each other. Further, the void 8 communicate from the upper side to the lower side of the active material molded body 3 in the drawing, and by the communicating void 8, a pathway through which a fluid can move is formed.

In this step, as the active material particles 7, a powder of the above-mentioned positive electrode active material or negative electrode active material can be used. The average particle diameter of the active material particles 7 is preferably 300 nm or more and 5 μm or less. When an active material having such an average particle diameter is used, the void ratio of the obtained active material molded body 3 falls within the range of 10% to 40%. As a result, a surface area of the inside of the voids of the active material molded body 3 is increased, and also a contact area between the active material molded body 3 and the solid electrolyte layer 4 is easily increased. Accordingly, the capacity of a lithium battery using the electrode assembly 1 is easily increased. The average particle diameter of the active material particles 7 can be determined by dispersing the active material particles 7 in n-octanol at a concentration ranging from 0.1 to 10% by mass, and then, measuring the median diameter using a light scattering particle size distribution analyzer (Nanotrac UPA-EX250, manufactured by Nikkiso Co., Ltd.).

If the average particle diameter of the active material particles 7 is less than 300 nm, the average radius of the voids 8 to be contained in the formed active material molded body 3 tends to be as small as several tens of nanometers, and the voids 8 are not formed. Due to this, it becomes difficult to allow a liquid material containing a precursor of an inorganic solid electrolyte to penetrate into the voids 8. As a result, it becomes difficult to form the solid electrolyte layer 4 to be in contact with the surface of the active material particles 7.

If the average particle diameter of the active material particles 7 exceeds 5 μm, a specific surface area which is a surface area per unit mass of the formed active material molded body is decreased, and thus, a contact area between the active material molded body 3 and the solid electrolyte layer 4 is decreased. Therefore, when forming a lithium battery using the obtained electrode assembly 1, a sufficient output power cannot be obtained. Further, the ion diffusion distance from the inside of the active material to the solid electrolyte layer 4 is increased, and therefore, it becomes difficult for the active material around the center of the active material particle 7 to contribute to the function of a battery. The average particle diameter of the active material particles 7 is more preferably 450 nm or more and 3 μm or less, further more preferably 500 nm or more and 1 μm or less.

When press-molding the powder, a binder composed of an organic polymer compound such as polyvinylidene fluoride (PVdF) or polyvinyl alcohol (PVA) may be added to the active material particles 7. Such a binder is removed by burning or oxidation in the heat treatment in this step, and the amount thereof remaining in the active material molded body 3 is reduced.

The heat treatment in this step is performed at a treatment temperature of 850° C. or higher and lower than the melting point of the active material particles 7. By this heat treatment, the active material particles 7 are sintered with one another, whereby an integrated active material molded body 3 is formed. By performing the heat treatment at a temperature in such a range, an active material molded body 3 having a resistivity of 700 Ω/cm or less can be obtained without adding a conductive additive. Accordingly, when forming a lithium battery using the electrode assembly 1, a sufficient output power can be obtained.

If the treatment temperature is lower than 850° C., sintering does not sufficiently proceed. Further, the electron conductivity itself in the crystals of the active material is decreased, and therefore, when forming a lithium battery using the electrode assembly 1, a desired output power cannot be obtained. Further, if the treatment temperature exceeds the melting point of the active material, lithium ions are excessively volatilized from the inside of the crystals of the active material, and therefore, the electron conductivity is decreased, and thus, the capacity of the electrode assembly 1 is decreased.

Accordingly, in order to obtain an appropriate output power and capacity, the heat treatment temperature is preferably 850° C. or higher and lower than the melting point of the active material, more preferably 875° C. or higher and 1000° C. or lower. Still further, the heat treatment temperature is most preferably 900° C. or higher and 920° C. or lower. The heat treatment in this step is performed for preferably 5 minutes or more and 36 hours or less, more preferably 4 hours or more and 14 hours or less.

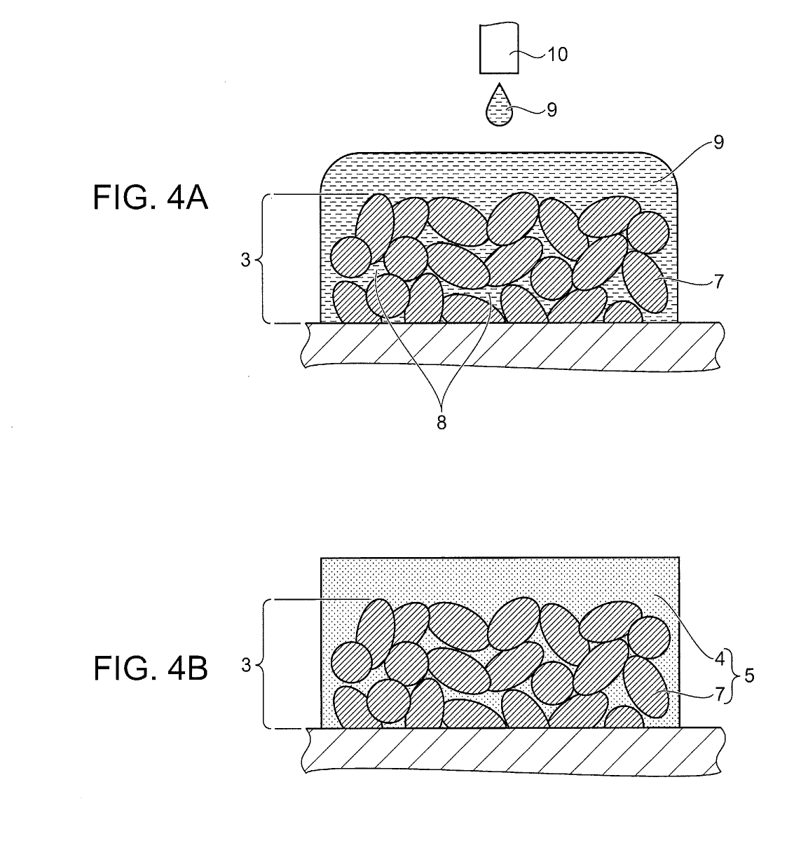

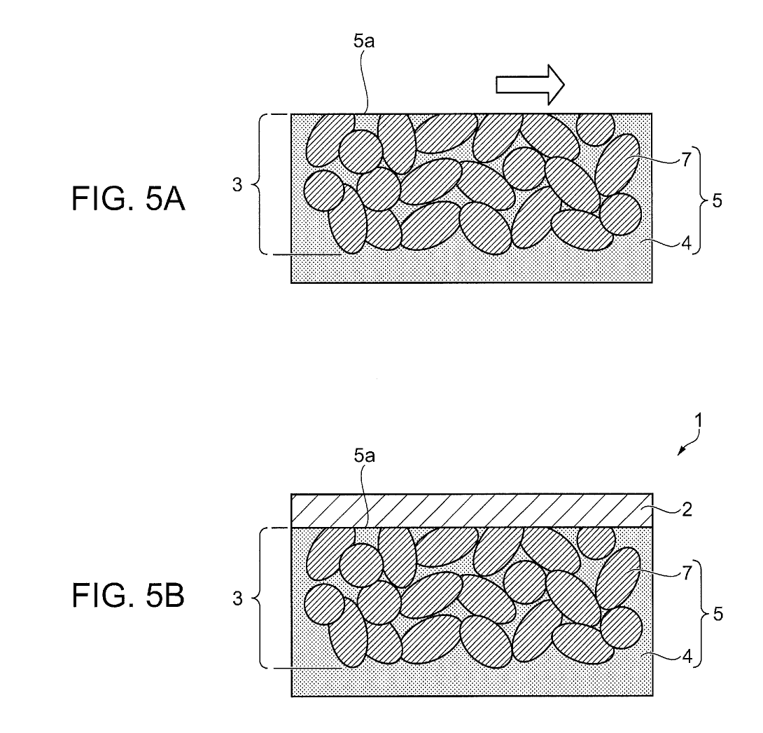

FIGS. 4A and 4B are views corresponding to the electrolyte layer forming step of Step S2. As shown in FIG. 4A, in Step S2, a liquid electrolyte material 9 containing a precursor of the solid electrolyte layer 4 is prepared. In the liquid electrolyte material 9, a solvent which lowers the melting point of the precursor is contained. The solvent is a salt, and as the solvent, other than an oxoacid salt, any of various chlorides can be used. The liquid electrolyte material 9 is a liquid obtained by melting by heating to a temperature lower than the melting point of the active material particles 7. Since the melting point of LiCoO₂ which forms the active material particles 7 is from 1050° C. to 1100° C., the active material particles 7 are melted at a temperature of 1050° C.

Examples of the precursor of the solid electrolyte layer 4 include the following precursors (A), (B), and (C): (A) a composition including a salt which contains a metal atom to be contained in the inorganic solid electrolyte at a ratio according to the compositional formula of the inorganic solid electrolyte, and is converted to the inorganic solid electrolyte by oxidation; (B) a composition including a metal alkoxide containing a metal atom to be contained in the inorganic solid electrolyte at a ratio according to the compositional formula of the inorganic solid electrolyte; and (C) a composition in which the inorganic solid electrolyte in the form of fine particles or a sol in the form of fine particles containing a metal atom to be contained in the inorganic solid electrolyte at a ratio according to the compositional formula of the inorganic solid electrolyte is dispersed in a solvent, or (A), or (B). The precursor (B) is a precursor when the inorganic solid electrolyte is formed using a so-called sol-gel method.

The liquid electrolyte material 9 is melted at a temperature lower than the melting point of the active material particles 7 and placed in a dispenser 10. The dispenser 10 is provided with a heater and a temperature sensor, and the liquid electrolyte material 9 is maintained within a predetermined temperature range. Then, from the dispenser 10, the liquid electrolyte material 9 is dropped onto the active material molded body 3. According to this, the liquid electrolyte material 9 having fluidity is applied to the active material molded body 3. In the active material molded body 3, voids 8 communicating with one another are formed. In the voids 8, the liquid electrolyte material 9 is allowed to flow. In this manner, the liquid electrolyte material 9 is placed in contact with the surface of the active material molded body 3 facing the fine voids 8. As a result, a contact area between the active material molded body 3 and the liquid electrolyte material 9 can be increased.

The application of the liquid electrolyte material 9 is performed by any method as long as the method can allow the liquid electrolyte material 9 to penetrate into the voids 8 in the active material molded body 3, and various methods can be used. For example, the application may be performed by immersing the active material molded body 3 in a vessel in which the liquid electrolyte material 9 is pooled. Other than this, an edge portion of the active material molded body 3 is brought into contact with a place where the liquid electrolyte material 9 is pooled so that the voids 8 are impregnated with the liquid electrolyte material 9 by utilizing a capillary phenomenon, whereby the liquid electrolyte material 9 may be placed on the active material molded body 3.

A temperature profile for cooling the precursor can be performed by various methods. For example, a temperature at which a crystal of the solid electrolyte layer 4 is deposited may be maintained for a predetermined time. The crystallinity of the solid electrolyte layer 4 is improved, and the ionic conductivity of the solid electrolyte layer 4 can be improved. In addition, the size of the crystal may be controlled by performing slow cooling, or an amorphous electrolyte may be formed by performing rapid cooling. In the cooling process, the inorganic solid electrolyte is produced from the precursor, whereby the solid electrolyte layer 4 is formed. Since a contact area between the active material molded body 3 and the solid electrolyte layer 4 is increased, a current density at an interface between the active material molded body 3 and the solid electrolyte layer 4 is decreased, and thus, a high output power can be obtained.

Further, the crystal grain size of the solid electrolyte layer 4 may be adjusted by firing. The firing is performed in an air atmosphere at a temperature lower than the temperature in the heat treatment for obtaining the active material molded body 3 described above. For example, the firing may be performed at a temperature of 300° C. or higher and 700° C. or lower.

The firing temperature profile is not particularly limited, and the firing may be performed by performing a heat treatment in which a predetermined temperature is maintained, or may be performed by dividing the heat treatment into a first heat treatment in which the precursor is adhered to the surface of the active material particles 7 and a second heat treatment in which heating is performed at a temperature not lower than the treatment temperature in the first heat treatment and 700° C. or lower. By performing the firing by such a stepwise heat treatment, the particle diameter of the solid electrolyte layer 4 can be controlled.

In the solid electrolyte layer 4, a solid electrolyte crystal is crystallized, and the remaining solvent is solidified into a glass electrolyte. According to this, a composite material in which a crystalline solid electrolyte and an amorphous electrolyte are combined is obtained. As a result, in the solid electrolyte layer 4, a crystalline electrolyte and an amorphous electrolyte are contained. In the solid electrolyte layer 4, a particle interface resistance of the crystalline solid electrolyte can be decreased by forming a composite material with the amorphous electrolyte.

As shown in FIG. 4B, the composite body 5 is formed from the active material molded body 3 and the solid electrolyte layer 4 obtained by solidifying the liquid electrolyte material 9. By performing such a treatment, a solid phase reaction occurs at an interface between the active material molded body 3 and the solid electrolyte layer 4 due to mutual diffusion of elements constituting the respective members, and the production of electrochemically inactive side products can be suppressed. Further, the crystallinity of the inorganic solid electrolyte is improved, and thus, the ionic conductivity of the solid electrolyte layer 4 can be improved. In addition, at the interface between the active material molded body 3 and the solid electrolyte layer 4, a closely adhered portion is generated, and thus, charge transfer at the interface is facilitated. Accordingly, the capacity and the output power of a lithium battery using the electrode assembly 1 are improved.

FIGS. 5A and 5B are views corresponding to the current collector bonding step of Step S3. As shown in FIG. 5A, in Step S3, a surface 5a of the composite body 5 is polished. By polishing the surface 5a of the composite body 5, the active material molded body 3 is reliably exposed on the surface 5a of the composite body 5, and thus, the current collector 2 and the active material molded body 3 can be reliably bonded to each other.

Incidentally, the active material molded body 3 may be sometimes exposed on the surface to be in contact with the mounting surface of the composite body 5 when forming the composite body 5. In this case, the current collector 2 and the active material molded body 3 may be bonded to each other without polishing the composite body 5.

Subsequently, as shown in FIG. 5B, the current collector 2 is bonded to the active material molded body 3 exposed on the surface 5a of the composite body 5 including the active material molded body 3 and the solid electrolyte layer 4, whereby the electrode assembly 1 is produced. Alternatively, the current collector 2 may be formed on the surface 5a of the composite body 5 by depositing a constituent material of the current collector 2 on the surface 5a of the composite body 5. As the deposition method, a generally known physical vapor deposition method (PVD) or chemical vapor deposition method (CVD) can be adopted. According to the above steps, the electrode assembly 1 is completed.

As described above, according to this embodiment, the following effects are obtained.

(1) According to this embodiment, the active material molded body 3 has voids 8 among the active material particles 7. Further, the melted liquid electrolyte material 9 is placed on the surface of the active material molded body 3. Since the liquid electrolyte material 9 spreads on the surface of the active material molded body 3 through the voids 8, the surface of the active material particles 7 can be reliably covered with the liquid electrolyte material 9.

(2) According to this embodiment, the liquid electrolyte material 9 is melted at a temperature lower than the melting point of the active material. According to this, it is possible to suppress the voids 8 among the active material particles 7 from being narrowed by the liquid electrolyte material 9. Accordingly, a contact area between the active material molded body 3 and the solid electrolyte layer 4 is increased, so that an interface impedance between the active material molded body 3 and the solid electrolyte layer 4 can be decreased. Due to this, favorable charge transfer at an interface between the active material molded body 3 and the solid electrolyte layer 4 can be achieved. As a result, an electrode assembly 1 which facilitates charge transfer and has a high output power can be produced.

(3) According to this embodiment, the liquid electrolyte material 9 contains a solvent which lowers the melting point of the precursor. Therefore, the precursor of the solid electrolyte layer 4 can be melted at a temperature lower than the melting point of the active material molded body 3.

(4) According to this embodiment, the liquid electrolyte material 9 contains a salt which lowers the melting point of the precursor. Therefore, the melting point of the precursor of the solid electrolyte layer 4 is lowered so that the precursor can be melted at a temperature lower than the melting point of the active material.

(5) According to this embodiment, the electrode assembly 1 is favorably used in a lithium battery, and a high-power lithium battery can be formed. That is, an electrode assembly capable of increasing the output power of a lithium battery can be easily produced.

(6) According to this embodiment, the liquid electrolyte material 9 is in the form of a liquid material having high fluidity by heating. Therefore, the liquid electrolyte material 9 easily flows in the voids 8. As a result, the liquid electrolyte material 9 can be efficiently applied to the active material molded body 3.

### Second Embodiment

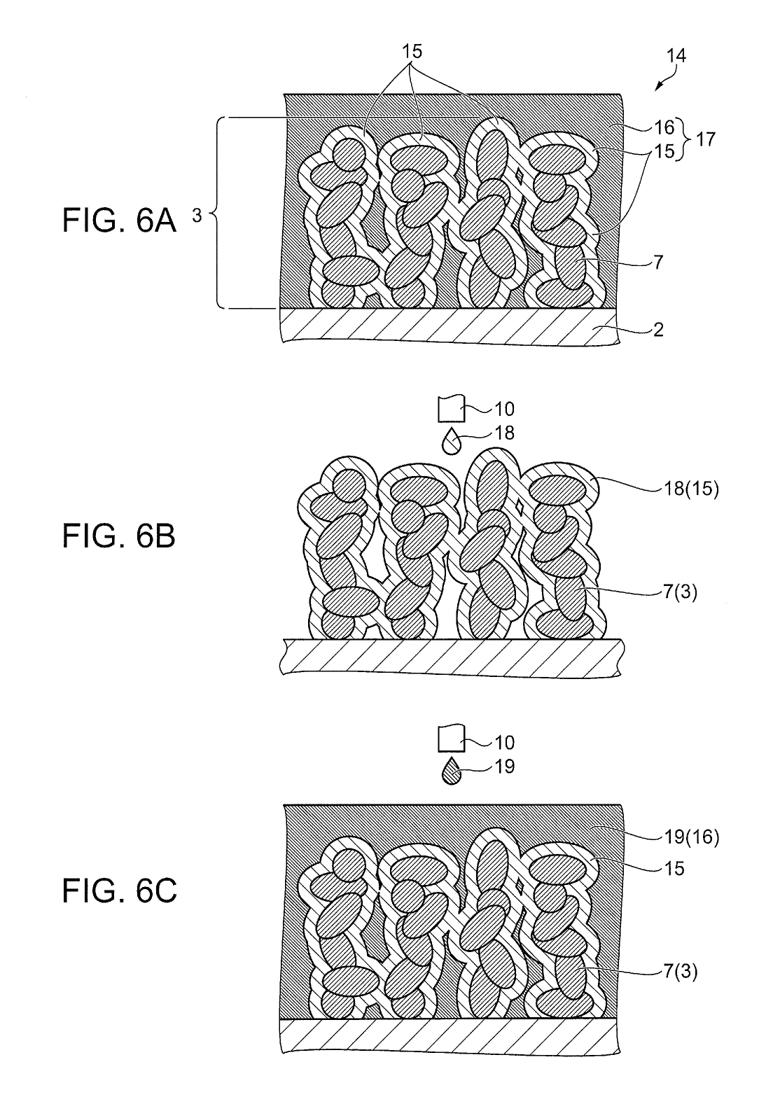

Next, another embodiment of the electrode assembly will be described with reference to FIGS. 6A to 6C. FIG. 6A is a schematic cross-sectional side view showing a structure of an electrode assembly, and FIGS. 6B and 6C are schematic views for illustrating a method for producing an electrode assembly. This embodiment is different from the first embodiment in that the solid electrolyte layer 4 is composed of two layers. A description of the same parts as in the first embodiment will be omitted.

In this embodiment, as shown in FIG. 6A, an electrode assembly 14 includes a current collector 2, and on the current collector 2, an active material molded body 3 is placed. The active material molded body 3 has a structure in which multiple active material particles 7 are bonded to one another while surrounding voids 8 in the same manner as in the first embodiment. A first electrolyte layer 15 is placed surrounding the active material particles 7. Further, a second electrolyte layer 16 is placed surrounding the first electrolyte layer 15. A solid electrolyte layer 17 as a solid electrolyte is formed from the first electrolyte layer 15 and the second electrolyte layer 16.

The first electrolyte layer 15 is an electrolyte layer which hardly changes its structure even if it comes in contact with the active material particles 7, and the second electrolyte layer 16 is an electrolyte layer which may change its structure when it comes in contact with the active material particles 7. The first electrolyte layer 15 functions as a protective film which protects the second electrolyte layer 16 from changing its structure. For example, when the active material particles 7 are composed of LiCoO₂, lithium lanthanum zirconate can be used for the first electrolyte layer 15. For the second electrolyte layer 16, multiple compounds selected from Li₃BO₃, Li₂CO₃, Li₃PO₄, Li₂SiO₃, Li₄SiO₄, Li₂SO₄, LiI, and the like can be used.

FIGS. 6B and 6C are views corresponding to the electrolyte layer forming step of Step S2. As shown in FIG. 6B, in Step S2, a first liquid electrolyte material 18 is placed in a dispenser 10. The first liquid electrolyte material 18 is a liquid obtained by adding a salt as a solvent to a precursor of the first electrolyte layer 15 and melting the precursor by heating. As the salt serving as the solvent, LiCl or NaCl can be used. Then, the precursor is melted at a temperature lower than the melting point of the active material particles 7.

The first liquid electrolyte material 18 is dropped from the dispenser 10 onto the active material molded body 3 and placed such that the first liquid electrolyte material 18 covers the active material particles 7. Then, the first liquid electrolyte material 18 is solidified according to a predetermined temperature profile, whereby the first electrolyte layer 15 is formed.

Subsequently, as shown in FIG. 6C, a second liquid electrolyte material 19 is placed in the dispenser 10. The second liquid electrolyte material 19 is a liquid obtained by adding a salt as a solvent to a precursor of the second electrolyte layer 16 and melting the precursor by heating. As the salt serving as the solvent, a zirconium salt or a lanthanum salt can be used. Then, the precursor is melted at a temperature lower than the melting point of the active material particles 7.

The second liquid electrolyte material 19 is dropped from the dispenser 10 onto the active material molded body 3 and placed such that the second liquid electrolyte material 19 covers the first electrolyte layer 15. Then, the second liquid electrolyte material 19 is solidified according to a predetermined temperature profile, whereby the second electrolyte layer 16 is formed.

When each of the first liquid electrolyte material 18 and the second liquid electrolyte material 19 is maintained at a temperature at which each material is crystallized for a long time, the first electrolyte layer 15 and the second electrolyte layer 16 have a crystalline structure. On the other hand, when each of the materials is cooled so as to pass through the temperature at which each material is crystallized in a short time, the materials have an amorphous structure. Accordingly, by controlling the cooling temperature profile, it is possible to control whether the first liquid electrolyte material 18 and the second liquid electrolyte material 19 are crystallized or amorphousized.

When the first electrolyte layer 15 is made crystalline and the second electrolyte layer 16 is made amorphous, the flowability of electrical charge between the first electrolyte layer 15 and the second electrolyte layer 16 can be enhanced. In the same manner, also when the first electrolyte layer 15 is made amorphous and the second electrolyte layer 16 is made crystalline, the flowability of electrical charge between the first electrolyte layer 15 and the second electrolyte layer 16 can be enhanced. The configuration is not limited thereto, and both of the first electrolyte layer 15 and the second electrolyte layer 16 may be made crystalline, and also both of the first electrolyte layer 15 and the second electrolyte layer 16 may be made amorphous. A crystallization combination which provides a high flowability of electrical charge may be selected.

As described above, according to this embodiment, the following effects are obtained.

(1) According to this embodiment, by placing the first electrolyte layer 15 between the active material molded body 3 and the second electrolyte layer 16, the second electrolyte layer 16 can be prevented from deteriorating. Accordingly, the service life of the electrode assembly 14 can be prolonged.

(2) According to this embodiment, it is controlled whether the first electrolyte layer 15 and the second electrolyte layer 16 are made crystalline or not. Accordingly, the flowability of electrical charge between the first electrolyte layer 15 and the second electrolyte layer 16 can be enhanced.

### Third Embodiment

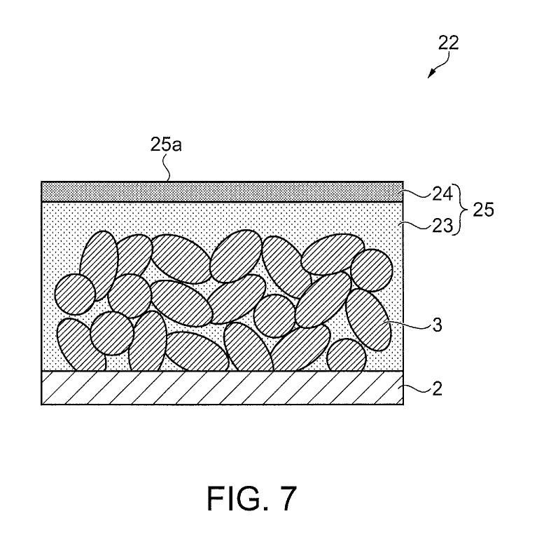

Next, another embodiment of the electrode assembly will be described with reference to FIG. 7. FIG. 7 is a schematic cross-sectional side view showing a structure of an electrode assembly. This embodiment is different from the first embodiment in that the solid electrolyte layer 4 is composed of two layers in the thickness direction. A description of the same parts as in the first embodiment will be omitted.

In this embodiment, as shown in FIG. 7, an electrode assembly 22 includes a current collector 2, and on the current collector 2, an active material molded body 3 is placed. A first electrolyte layer 23 is placed covering the active material molded body 3. A second electrolyte layer 24 is placed thinly in contact with the surface of the first electrolyte layer 23. The first electrolyte layer 23 and the second electrolyte layer 24 form a solid electrolyte layer 25 as a solid electrolyte as a whole. The volume of the second electrolyte layer 24 is smaller than the volume of the first electrolyte layer 23.

The solid electrolyte layer 25 having multiple layers laminated on each other can be produced by performing the method for forming the solid electrolyte layer 4 for each layer. The first electrolyte layer 23 is formed by applying a liquid electrolyte material 9 obtained by melting a precursor containing a salt as a solvent by heating to the active material molded body 3 in the same manner as in the first embodiment. At this time, the temperature of the liquid electrolyte material 9 is lower than the melting point of the active material molded body 3. Then, the material is solidified by cooling according to a predetermined temperature profile, whereby the first electrolyte layer 23 is formed.

Subsequently, a second liquid electrolyte material for forming the second electrolyte layer 24 is applied, followed by a heat treatment, whereby the precursor is adhered. Thereafter, a heat treatment may be performed for the precursor for the adhered multiple layers. Also for the second electrolyte layer 24, in the same manner as in the first electrolyte layer 23, the formation may be performed by applying the liquid electrolyte material 9 obtained by melting a precursor containing a salt as a solvent by heating to the active material molded body 3. Then, the material is solidified by cooling according to a predetermined temperature profile, whereby the second electrolyte layer 24 may be formed.

As the constituent materials of the first electrolyte layer 23 and the second electrolyte layer 24, the same constituent materials as those of the solid electrolyte layer 4 in the first embodiment can be adopted. The constituent materials of the first electrolyte layer 23 and the second electrolyte layer 24 may be the same as or different from each other. By providing the second electrolyte layer 24, the active material molded body 3 is not exposed on the surface 25a of the solid electrolyte layer 25. Accordingly, when a lithium battery having the electrode assembly 22 is produced by providing an electrode on the surface 25a, a short circuit caused by connecting the electrode provided on the surface 25a to the current collector 2 through the active material molded body 3 can be prevented.

Further, when a lithium battery including the electrode assembly 22 is produced, an alkali metal is sometimes selected as a material of an electrode to be formed. At this time, depending on the material of an inorganic solid electrolyte constituting the first electrolyte layer 23, due to the reducing activity of the alkali metal, the inorganic solid electrolyte constituting the first electrolyte layer 23 is reduced so that the function of the solid electrolyte layer may be lost. In such a case, when an inorganic solid electrolyte which is stable for the alkali metal is selected as the constituent material of the second electrolyte layer 24, the second electrolyte layer 24 functions as a protective layer for the first electrolyte layer 23, and thus, the degree of freedom of choosing the material of the first electrolyte layer 23 is increased.

### Fourth Embodiment

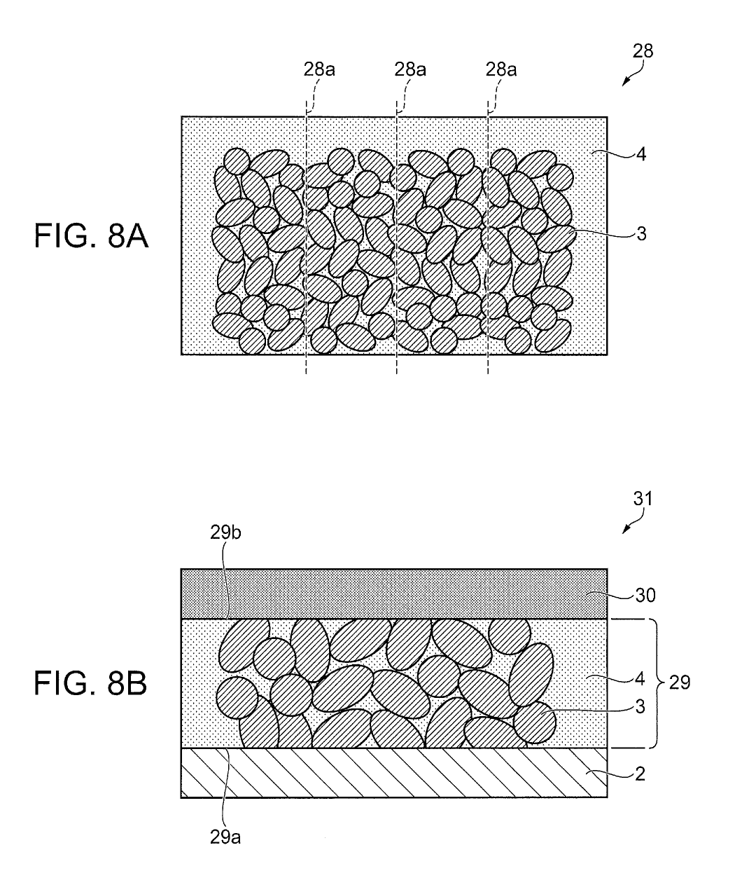

Next, another embodiment of the electrode assembly will be described with reference to FIGS. 8A and 8B. FIGS. 8A and 8B are schematic views for illustrating a method for producing an electrode assembly. This embodiment is different from the first embodiment in that a composite body 29 is produced by dividing a bulk body. A description of the same parts as in the first embodiment will be omitted.

In this embodiment, as shown in FIG. 8A, a bulk body 28 which is a structural body in which an active material molded body 3 and a solid electrolyte layer 4 are combined is formed. The bulk body 28 is formed by applying a liquid electrolyte material 9 obtained by melting a precursor containing a salt as a solvent by heating to the active material molded body 3 in the same manner as in the first embodiment. At this time, the temperature of the liquid electrolyte material 9 is lower than the melting point of the active material molded body 3. Then, the material is solidified by cooling according to a predetermined temperature profile, whereby the bulk body 28 is formed.

Subsequently, the bulk body 28 is divided into multiple segments in accordance with the size of the objective composite body 29. The bulk body is divided so that the multiple divided surfaces 28a face each other. Further, the division is performed by cleaving at the multiple divided surfaces 28a in the longitudinal direction of the bulk body 28 so that the tangent lines of the divided surfaces 28a extend in the direction intersecting the longitudinal direction of the bulk body 28.

Subsequently, as shown in FIG. 8B, for a composite body 29 obtained by cleaving the bulk body 28, a current collector 2 is placed on a first surface 29a (one surface of the composite body 29). Further, on a second surface 29b (the other surface of the composite body 29), an upper electrolyte layer 30 which covers the active material molded body 3 exposed on the second surface 29b is formed. The upper electrolyte layer 30 is a layer having the same function as that of the second electrolyte layer 24 in the third embodiment. The current collector 2 and the upper electrolyte layer 30 can be formed by the methods described above. In this manner, an electrode assembly 31 is produced.

As described above, according to the method for producing the electrode assembly 31, the composite body 29 is formed by forming the bulk body 28 in advance and dividing the bulk body 28. Accordingly, the electrode assembly 31 capable of forming a high-power lithium battery can be produced with high productivity.

### Fifth Embodiment

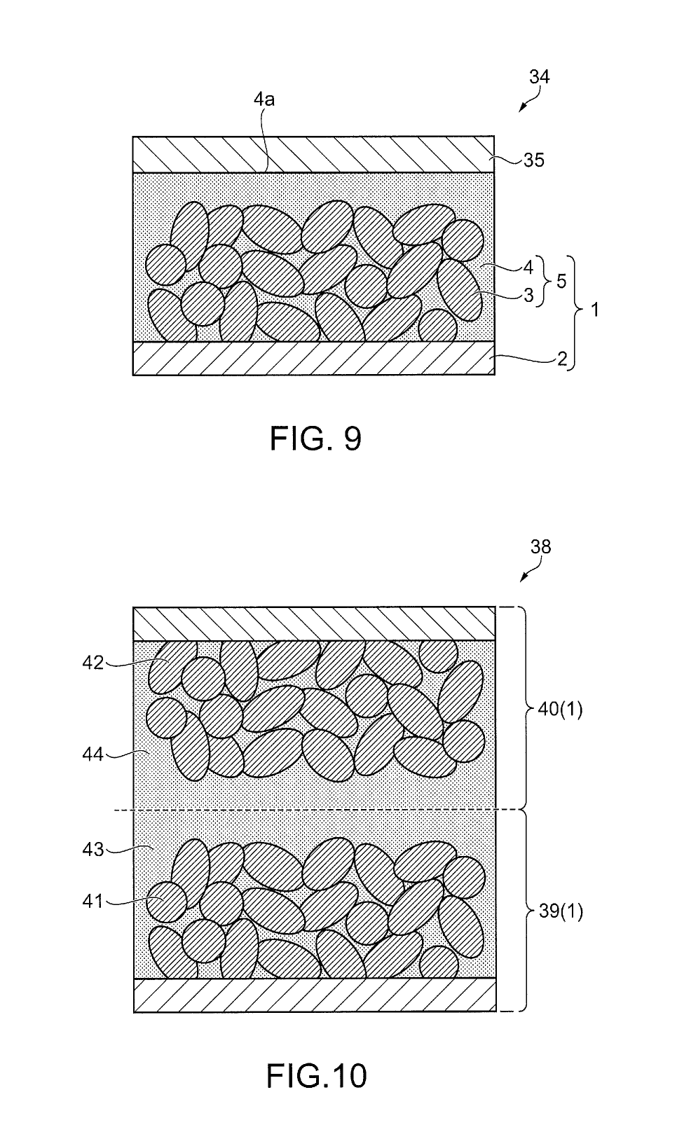

Next, an embodiment of the lithium battery will be described with reference of FIG. 9. FIG. 9 is a schematic cross-sectional side view of a main part showing a structure of a lithium battery. As shown in FIG. 9, a lithium battery 34 includes the above-mentioned electrode assembly 1 and an electrode 35 provided on a surface 4a of the solid electrolyte layer 4 in the electrode assembly 1. In the case where the constituent material of the active material molded body 3 is a positive electrode active material, the current collector 2 serves as a current collector on the positive electrode side, and the electrode 35 serves as a negative electrode. In the case where the constituent material of the active material molded body 3 is a negative electrode active material, the current collector 2 serves as a current collector on the negative electrode side, and the electrode 35 serves as a positive electrode.

For example, in the case where the constituent material of the active material molded body 3 is a positive electrode active material, as the constituent material of the current collector 2, aluminum can be selected, and as the constituent material of the electrode 35 which functions as a negative electrode, lithium can be selected.

In the lithium battery 34, the above-mentioned electrode assembly 1 is used. The solid electrolyte layer 4 of the electrode assembly 1 is formed by applying the liquid electrolyte material 9 obtained by melting a precursor containing a salt as a solvent by heating to the active material molded body 3. At this time, the temperature of the liquid electrolyte material 9 is lower than the melting point of the active material molded body 3. Then, the material is solidified by cooling according to a predetermined temperature profile, whereby the solid electrolyte layer 4 is formed. Accordingly, in the composite body 5, the solid electrolyte layer 4 is placed in the voids 8 in the active material molded body 3 with no gap, and thus, the lithium battery 34 has a high output power and a large capacity.

### Sixth Embodiment

Next, another embodiment of the lithium battery will be described with reference of FIG. 10. FIG. 10 is a schematic cross-sectional side view of a main part showing a structure of a lithium battery. As shown in FIG. 10, in a lithium battery 38, the above-mentioned electrode assembly 1 is provided on the positive electrode side and the negative electrode side. That is, the lithium battery 38 is provided with a first electrode assembly 39 as the electrode assembly on the positive electrode side and a second electrode assembly 40 as the electrode assembly on the negative electrode side, and is configured such that the solid electrolyte layers of the first electrode assembly 39 and the second electrode assembly 40 are allowed to abut on each other and integrated with each other.

In the first electrode assembly 39, as the constituent material of a first active material molded body 41 serving as the active material molded body, a positive electrode active material is used. In the second electrode assembly 40, as the constituent material of a second active material molded body 42 serving as the active material molded body, a negative electrode active material is used. A first solid electrolyte layer 43 as the solid electrolyte serving as the solid electrolyte layer of the first electrode assembly and a second solid electrolyte layer 44 as the solid electrolyte serving as the solid electrolyte layer of the second electrode assembly 40 may be composed of the same material or different materials.

The first electrode assembly 39 and the second electrode assembly 40 in the lithium battery 38 have the same structure as that of the above-mentioned electrode assembly 1. The first solid electrolyte layer 43 of the first electrode assembly 39 is formed by applying a liquid electrolyte material obtained by melting a precursor containing a salt as a solvent by heating to the first active material molded body 41. At this time, the temperature of the liquid electrolyte material is lower than the melting point of the first active material molded body 41. Then, the material is solidified by cooling according to a predetermined temperature profile, whereby the first solid electrolyte layer 43 is formed. Accordingly, in the first electrode assembly 39, the first solid electrolyte layer 43 is placed in the voids 8 in the first active material molded body 41 with no gap.

In the same manner, the second solid electrolyte layer 44 of the second electrode assembly 40 is formed by applying a liquid electrolyte material obtained by melting a precursor containing a salt as a solvent by heating to the second active material molded body 42. At this time, the temperature of the liquid electrolyte material is lower than the melting point of the second active material molded body 42. Then, the material is solidified by cooling according to a predetermined temperature profile, whereby the second solid electrolyte layer 44 is formed. Accordingly, in the second electrode assembly 40, the second solid electrolyte layer 44 is placed in the voids 8 in the second active material molded body 42 with no gap. As a result, the lithium battery 38 has a high output power and a high capacity.

The embodiments are not limited to the above-mentioned embodiments, and various modifications and changes can be made by a person with an ordinary skill in the art within the technical ideas of the invention. Hereinafter, Modification Examples will be described.

### Modification Example 1

In the first embodiment described above, the active material molded body 3 is formed by press-molding a powder, however, the method is not limited thereto. For example, a production method in which an active material molded body having voids 8 is obtained by mixing as a void template, a polymer or a carbon powder in the form of particles as a void-forming material in a raw material when preparing an active material molded body by a generally known sol-gel method, thereby forming an active material while decomposing and removing the void-forming material during heating may be adopted.

### Modification Example 2

In the first embodiment described above, after preparing the composite body 5 by forming the solid electrolyte layer 4 on the active material molded body 3, the current collector 2 is bonded to the active material molded body 3, but the method is not limited thereto. For example, after bonding the foil-shaped current collector 2 to the active material molded body 3, the solid electrolyte layer 4 may be formed on the active material molded body 3. Since the electrode assembly can also be produced by performing the steps in such an order, the degree of freedom of the production steps is increased. Further, the active material molded body 3 and the current collector 2 can be reliably bonded to each other.

### Modification Example 3

In the third embodiment described above, the first electrolyte layer 23 is placed covering the active material molded body 3. A configuration in which the active material molded body 3 is covered with the first electrolyte layer 15, and further the first electrolyte layer 15 is covered with the second electrolyte layer 16 in the same manner as in the second embodiment may be adopted. The deterioration of the second electrolyte layer 16 is prevented, and therefore, the service life of the electrode assembly 22 can be prolonged. This configuration can also be applied to the electrode assembly 31 of the fourth embodiment, the lithium battery 34 of the fifth embodiment, and the lithium battery 38 of the sixth embodiment.

What is claimed is:

1. A method for producing an electrode assembly, comprising:
preparing a liquid electrolyte material;
placing the liquid electrolyte material on a surface of an active material molded body having multiple voids; and
forming a solid electrolyte by solidifying the liquid electrolyte material, wherein
the liquid electrolyte material contains a precursor of the solid electrolyte and is melted at a temperature lower than the melting point of the active material molded body.

2. The method for producing an electrode assembly according to claim 1, wherein the liquid electrolyte material contains a solvent which lowers the melting point of the precursor.

3. The method for producing an electrode assembly according to claim 2, wherein the solvent is a salt.

4. The method for producing an electrode assembly according to claim 1, wherein the solid electrolyte contains a crystalline electrolyte and an amorphous electrolyte.

5. An electrode assembly, comprising:
an active material molded body having voids; and
a solid electrolyte covering a surface of the active material molded body including portions of the voids, wherein
the solid electrolyte contains a crystalline electrolyte and an amorphous electrolyte.

6. A lithium battery, comprising the electrode assembly according to claim 5 and an electrode provided in contact with the electrode assembly.
